(19) United States
(12) Patent Application Publication
(10) Pub. No.: US 2012/0039698 A1
(43) Pub. Date: Feb. 16, 2012

(54) APPARATUS FOR ALIGNING A SURFACE OF AT LEAST ONE OBJECT

(75) Inventors: Glen Hoppes, Bochum (DE); Raymond Puffer, Watervliet, NY (US); Mike Kokko, Arlington, MA (US)

(73) Assignee: BASF SE, LUDWIGSHAFEN (DE)

(21) Appl. No.: 13/266,372

(22) PCT Filed: May 4, 2010
(86) PCT No.: PCT/EP10/02705

§ 371 Date: Oct. 26, 2011

(51) Int. Cl. B65G 47/74

(52) U.S. Cl. 414/749.1; 414/800

(57) ABSTRACT

An apparatus for aligning a surface of at least one object (39) that extends in the XY plane,
comprising
   at least one movable base plate (1) with a surface extending in the XY plane,
   above the base plate (1) in the Z direction, at least one mask (3) with at least one aperture (5), the mask (3) and the aperture (5) respectively extending in the XY plane,
   at least one means (25) for moving the base plate (1) in a first direction within the XY plane,
   at least one means (27) for moving the base plate (1) in a second direction within the XY plane.

The apparatus is preferably used on the basis of a procedure in which
(1) the apparatus according to the invention in which the distance between the base plate (1) and the mask (3) in the Z direction is less than the spatial extent of the object (39) in the Z direction is used,
(2) the object (39) is placed onto the base plate (1) in the region of the aperture (5) in the mask (3),
(3) the base plate (1) is initially moved in the first direction,
(4) the base plate (1) is subsequently moved in the second direction,
(5) the base plate (1) is then moved in a third direction within the XY plane that lies between the first and second directions.

The present invention relates to an apparatus for aligning a surface of at least one object, in particular an electrode.

### PRIOR ART

Electrodes are known per se and are used for example in membrane electrode units for fuel cells. Membrane electrode units of this type generally comprise two electrodes, which are separated from each other by a suitable membrane that acts as an electrolyte. Among the factors determining the performance of such membrane electrode units is the contact area between the electrodes and the membrane.

During the production of the membrane electrode units, it must therefore be ensured in particular that the electrodes and the membrane lie one on top of the other as exactly as possible with their surface areas in contact, in order to achieve a contact area that is as large as possible. Regions of the electrodes and/or of the membrane that are not in contact are optionally removed, in order as far as possible to minimize the space requirement for the membrane electrode unit.

Automating the production of such membrane electrode units is therefore a particular challenge. On the one hand, the intention is to make it possible for the membrane electrode units to be produced as quickly, efficiently and reproducibly as possible. On the other hand, the aim is to achieve a solution that is as inexpensive as possible, which ultimately requires placement of the electrodes on the membrane as exactly as possible in order to maximize the performance of the membrane electrode units in relation to the amount of electrode material and membrane material used and to minimize the amount of scrap material without any contact area.

This is where the known methods and devices for automating such a procedure meet their limits. They are too complicated, too slow, too inexact, not suitable for flexible materials such as electrodes, too time-consuming and/or too expensive.

### SUMMARY OF THE INVENTION

In the light of this prior art, it was an object of the present invention to present possibilities for the better production of membrane electrode units. At the same time, the aim was to achieve a solution that is as quick as possible, as effective as possible, as simple as possible, as reproducible as possible and as inexpensive as possible.

This and other objects that are obvious from the interrelated aspects discussed at the beginning are achieved by an apparatus with all the features of the present patent claim 1. Particularly expedient refinements of the apparatus are described in the related subclaims. A particularly suitable procedure for aligning a surface of at least one object is also afforded protection.

The subject matter of the present invention is accordingly an apparatus for aligning a surface of at least one object that extends in the XY plane, comprising
at least one movable base plate with a surface extending in the XY plane,
above the base plate in the Z direction, at least one mask with at least one aperture, the mask and the aperture respectively extending in the XY plane,
at least one means for moving the base plate in a first direction within the XY plane, preferably in the X direction,
at least one means for moving the base plate in a second direction within the XY plane that is not parallel to the first direction, preferably in the Y direction.

This apparatus allows extremely precise alignment of a surface of at least one object, such as for example an electrode, in a prescribed way, it being possible for the knowledge of the known alignment of the object to be advantageously used in subsequent procedural steps.

The apparatus is therefore particularly suitable for the alignment of electrodes during automated production of membrane electrode units.

### FIGURES

The invention is explained in more detail below with reference to the accompanying figures, without intending to restrict the concept of the invention.

In the figures:

FIG. 1 shows a schematic exploded representation of a preferred embodiment of an apparatus according to the invention,

FIG. 2 shows a schematic perspective view of a preferred embodiment of an apparatus according to the invention,

FIG. 3 to FIG. 6 show a schematic plan view of a preferred embodiment of an apparatus according to the invention during the alignment of a surface of a number of objects, where

FIG. 3 shows the positions of the objects to be aligned at the beginning,

FIG. 4 shows the positions of the objects after a first movement of the base plate in the Y direction,

FIG. 5 shows the positions of the objects after a second movement of the base plate in the X direction and

FIG. 6 shows the positions of the objects after a third movement of the base plate in the XY direction.

### DESCRIPTION OF THE INVENTION

The present invention relates to an apparatus for aligning a surface of at least one object, the surface to be aligned extending in the XY plane.

Within the scope of the present invention, an “extent in a direction” refers to a spatial extent in the direction referred to. An “extent in a plane” accordingly refers to a spatial extent in the plane referred to.

In this connection, the statements made according to the invention relate to a three-dimensional system of Cartesian coordinates, i.e. a system of orthogonal coordinates which comprises a horizontal X axis, a vertical Y axis and a spatial Z axis.

The apparatus according to the invention comprises
at least one movable base plate with a surface extending in the XY plane,
above the base plate in the Z direction, at least one mask with at least one aperture, the mask and the aperture respectively extending in the XY plane,
at least one means for moving the base plate in a first direction within the XY plane,
at least one means for moving the base plate in a second direction within the XY plane.

In this case, the second direction is not parallel to the first direction. The angle between the associated directional vectors is accordingly in the range from >0° to less than 180°, preferably in the range from 60° to 120°, particularly preferably in the range from 75° to 105°, in particular in the range from 85° to 95°.

The surface of the side of the base plate that is facing the mask is preferably smooth, in order to ensure greatest possible surface-area contact of the object to be aligned with the base plate. In this connection, “smooth” means that the base plate has a surface that is as planar as possible, as far as possible without roughnesses and/or unevennesses. Preferably, the average roughness Rₐ of the surface, measured in accordance with DIN 4768, is less than 25 μm, in particular less than 16 μm.

According to a particularly preferred embodiment of the present invention, the base plate is produced from aluminum. The surface of the side of the base plate that is facing the mask preferably has an average roughness Rₐ, measured in accordance with DIN 4768, of less than 25 μm, in particular less than 16 μm, and is favorably anodized with a hard coating, preferably with Teflon.

The mask is preferably produced from the same material as the base plate, particularly preferably from aluminum. The surface of the side of the mask that is facing the base plate is expediently likewise smooth and preferably has an average roughness Rₐ, measured in accordance with DIN 4768, of less than 25 μm, in particular less than 16 μm, and is favorably not anodized with a hard coating, in particular not anodized with Teflon.

Within the scope of a particularly preferred embodiment of the present invention, an immovable plate is arranged below the base plate in the Z direction, in order to make a fixed position of the apparatus possible.

The base plate serves for moving the object to be aligned by transmitting the movement of the base plate to the object over their surface areas.

By contrast, the mask serves as it were as a negative for the alignment of the object, in that it does not move during the movement of the base plate, the object to be aligned butts against it and, if necessary, correspondingly changes its orientation (alignment).

The mask preferably comprises at least one aperture, which is adapted to the shape of the object to be aligned in the XY plane. Particularly preferred are apertures with 0 to 10 corners, in particular circular, ellipsoidal or otherwise shaped apertures having a curved perimeter without corners, triangular, quadrangular, in particular trapezoidal, square or rectangular, pentagonal, hexagonal, heptagonal, octagonal, nonagonal or decagonal apertures. Within the scope of a particularly advantageous embodiment, the aperture has 3 to 6 corners, in particular a square or rectangular cross-section, the first side of the square or rectangle preferably extending in the X direction and the second side of the square or rectangle preferably extending in the Y direction.

The size of the aperture is expediently chosen such that the aperture is capable of completely receiving the object to be aligned. It is preferably larger than the maximum cross-sectional area of the object to be aligned, viewed in each case in the XY plane.

Particularly preferably, the ratio of the area of the aperture to the maximum cross-sectional area of the object to be aligned, viewed in each case in the XY plane, is in the range from >100% to 10 000%, preferably in the range from 140% to 1600%, in particular in the range from 200% to 400%.

The ratio of the maximum spatial extent of the aperture in the first direction, preferably in the X direction, to the maximum extent of the object to be aligned in the first direction, preferably in the X direction, is favorably in the range from >100% to 1000%, preferably in the range from 120% to 400%, in particular in the range from 150% to 200%.

The ratio of the maximum spatial extent of the aperture in the second direction, preferably in the Y direction, to the maximum extent of the object to be aligned in the second direction, preferably in the Y direction, is favorably in the range from >100% to 1000%, preferably in the range from 120% to 400%, in particular in the range from 150% to 200%.

The means for moving the base plate are not subject to any particular restrictions. They should merely allow a movement of the base plate in the first direction, preferably the X direction, or the second direction, preferably the Y direction, that is as targeted as possible and as uniform as possible. However, means which respectively comprise a rod and a drive for moving the rod have proven to be particularly successful, the rods preferably being connected to the base plate in order to make it possible for the movement of the rods to be transmitted as directly as possible to the base. plate. Particularly preferably, the first rod extends in the first direction, in particular in the X direction, and the second rod extends in the second direction, in particular in the Y direction.

Furthermore, the means for moving the base plate preferably comprise a first further plate, which expediently extends in the XY plane and is arranged below the base plate in the Z direction and is preferably connected fixedly, but particularly preferably releasably, to the base plate by way of suitable fastening means. This first further plate preferably serves for moving the base plate in at least one direction in the XY plane, particularly preferably in the first direction. It is therefore expediently connected to at least one means for moving this first plate in at least one direction in the XY plane, preferably the first direction.

Expediently arranged below this first further plate is a second further plate, which expediently likewise extends in the XY plane. This second further plate preferably serves for moving the base plate in at least one direction in the XY plane, particularly preferably in the second direction. It is therefore expediently connected to at least one means for moving this second plate in at least one direction in the XY plane, preferably the second direction.

Preferably arranged below the second further plate is a third further plate, which expediently likewise extends in the XY plane. This third further plate serves as a bed plate for the means for moving the base plate in the first and second directions and is intended to make easy modular maintenance of these means possible.

The second further plate is preferably not fixedly connected to the first further plate and the third further plate is preferably not fixedly connected to the second further plate, in order to make independent movement of the first and second further plates possible. Particularly preferably, the contact areas between the first further plate and the second further plate and/or between the second further plate and the third further plate are designed to be as free from friction as possible, in order to make easiest possible movement of the plates concerned in the corresponding directions possible. The use of ball bearings that are arranged between the plates concerned has proven to be particularly successful in this connection.

Furthermore, means for guiding the first further plate in the intended direction of movement, preferably in the first direction, are preferably arranged between the first further plate and the second further plate. Means for guiding the second further plate in the intended direction of movement, preferably in the second direction, are preferably arranged between the second further plate and the third further plate.

For determining and checking the exact position of the base plate in the XY plane, the apparatus according to the invention preferably comprises suitable sensors.

Within the scope of a particularly preferred embodiment of the present invention, the apparatus also comprises a frame with an aperture, the base plate and/or the mask being arranged within this aperture. The frame serves the purpose of keeping the spatial arrangement of the base plate and/or the mask in the Z direction as constant as possible. Therefore, the mask is preferably connected to the frame. The use of a number of frames engaging in one another is also conceivable in this connection.

The frame expediently comprises on its outer side means for guiding at least one drive along the outer side of the frame, in order in this way to ensure a position of the drive in the Z direction that is as constant as possible. Gaps which extend in the first and/or second direction, in particular in the X and/or Y direction, and at least partially receive the drive have proven to be particularly successful in this connection.

For the purposes of the present invention, the thickness of the object to be aligned may in principle be chosen freely. However, the procedure according to the invention has proven to be particularly successful for objects with a maximum extent in the Z direction in the range from 10 μm to 1 cm, preferably in the range from 50 μm to 1 mm, in particular in the range from 100 μm to 500 μm.

The distance between the base plate and the mask in the Z direction should be kept as small as possible, in order to achieve an alignment of the object that is as uniform as possible and in order to avoid as far as possible jamming of the object in the gap between the base plate and the mask. Particularly preferably, this distance is between 0% and 90%, in particular between 1% and 50%, of the maximum extent of the object to be aligned in the Z direction.

The contact area between the object to be aligned and the mask is preferably as great as possible, in order to achieve a uniform force transmission. This contact area is preferably at least 10%, particularly preferably at least 25%, in particular at least 50%, of the area of the object to be aligned, in each case viewed perpendicularly to the direction of movement at the time.

Finally, the apparatus preferably also comprises means for removing the aligned object. This makes it possible for an aligned object of exactly known three-dimensional position and alignment to be removed in an automated manner.

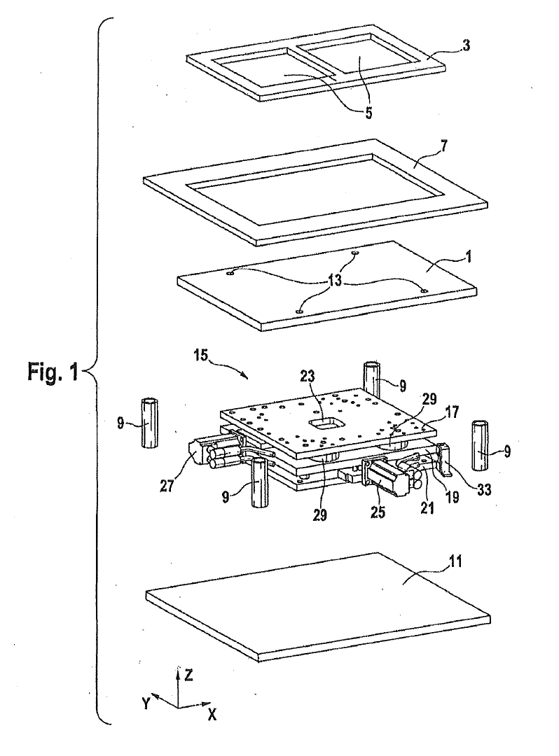

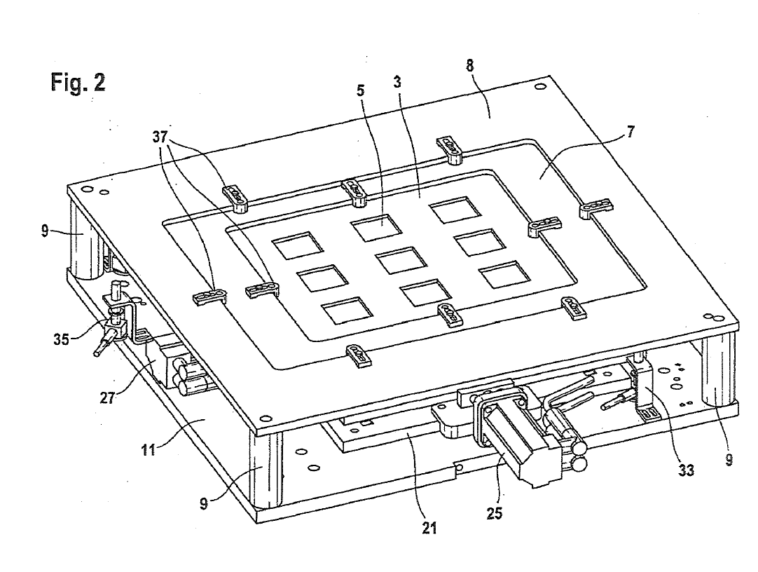

Particularly preferred embodiments of an apparatus according to the invention are represented in FIG. 1 and FIG. 2.

They comprise
a movable base plate (1) with a surface extending in the XY plane,
above the base plate in the Z direction, a mask (3) with two (FIG. 1) or three rows of three (FIG. 2) apertures (5), the mask (3) and the apertures (5) respectively extending in the XY plane and the number of apertures being intended only as examples,
means (25) for moving the base plate in the Y direction,
means (27) for moving the base plate in the X direction.

The surface of the side of the base plate (1) that is facing the mask is smooth and preferably has an average roughness Rₐ of the surface, measured in accordance with DIN 4768, of less than 25 μm, in particular less than 16 μm.

According to a particularly preferred embodiment of the present invention, the base plate (1) is produced from aluminum. The surface of the side of the base plate (1) that is facing the mask preferably has an average roughness Rₐ, measured in accordance with DIN 4768, of less than 25 μm, in particular less than 16 μm, and is favorably anodized with a hard coating, preferably with Teflon.

The mask (3) is preferably produced from the same material as the base plate (1), particularly preferably from aluminum. The surface of the side of the mask (3) that is facing the base plate (1) is expediently likewise smooth and preferably has an average roughness Rₐ, measured in accordance with DIN 4768, of less than 25 μm, in particular less than 16 μm, and is favorably not anodized with a hard coating, in particular not anodized with Teflon.

The apertures (5) respectively have a square or rectangular shape, the first side of the square or rectangle extending in the X direction and the second side of the square or rectangle extending in the Y direction.

The apparatus also comprises a frame (FIG. 1; 7) or two frames engaging in one another (FIG. 2; 7, 8) with an aperture, the mask (3) being arranged within this aperture. The frame (7, 8) serves the purpose of keeping the spatial arrangement of the mask (3) in the Z direction as constant as possible, and is therefore connected to the mask (3) by way of fastening means (37).

The means (15) for moving the base plate (1) comprise a first further plate (17), a second further plate (19) and a third further plate (21), which respectively extend in the XY plane. In this case, the first plate (17) is arranged below the base plate (1) in the Z direction and is connected fixedly, but releasably, to the base plate (1) by way of suitable fastening means (13). This first further plate (17) serves for moving the base plate in the Y direction. It is therefore connected to a means for moving this plate in the Y direction (25).

Arranged below the first further plate (17) is the second further plate (19). It serves for moving the base plate (1) in the X direction. It is therefore connected to a means for moving this second plate (19) in the X direction.

Arranged below the second further plate (19) is a third further plate (21). It serves as a bed plate for the means for moving the base plate in the first and second directions (15) and is intended to make easy modular maintenance of these means possible. The internals of the means (15) are accessible by way of an opening (23) in the first further plate (17).

The second further plate (19) is not fixedly connected to the first further plate (17) and the third further plate (21) is not fixedly connected to the second further plate (19), in order to make an independent movement of the first and second further plates (17, 19) possible. The contact areas between the first further plate (17) and the second further plate (19) and between the second further plate (19) and the third further plate (21) are designed to be free from friction, in order to make easiest possible movement of the plates (17, 19) concerned in the corresponding directions possible. For this purpose, ball bearings (29) are arranged between the plates concerned (17, 19, 21).

Furthermore, means for guiding the first further plate (17) in the Y direction are arranged between the first further plate (17) and the second further plate (19) (not represented). Means for guiding the second further plate (19) in the X direction are arranged between the second further plate (19) and the third further plate (21) (not represented).

For determining and checking the exact position of the base plate (1) in the XY plane, the apparatus comprises suitable sensors (33, 35).

The apparatus is mounted on a further bed plate (11) by means of suitable supports (9).

The apparatus according to the invention allows the alignment of a surface of at least one object that extends in the XY plane. Within the scope of a preferred embodiment of the present invention, a number of objects are aligned simultaneously.

Particularly favorable is a procedure in which
(1) an apparatus according to the invention in which the distance between the base plate and the mask in the Z direction is less than the spatial extent of the object in the Z direction is used,
(2) the object is placed onto the base plate in the region of the aperture in the mask,
(3) the base plate is initially moved in the first direction,
(4) the base plate is subsequently moved in the second direction,
(5) the base plate is then moved in a third direction within the XY plane that lies between the first and second directions.

The third direction is consequently not parallel to the first direction or the second direction. The angle between the first directional vector and the third direction vector is accordingly in the range from >0° to less than 180°, preferably in the range from 15° to 75°, particularly preferably in the range from 30° to 60°, in particular in the range from 40° to 50°. The angle between the second directional vector and the third directional vector is in the range from >0° to less than 180°, preferably in the range from 15° to 75°, particularly preferably in the range from 30° to 60°, in particular in the range from 40° to 50°.

According to a particularly preferred variant of the present invention, the base plate is
(3) initially moved in the X direction,
(4) subsequently moved in the Y direction,
(5) and then moved in the XY direction.

In this case, the sequence of steps (3) and (4) is reversible.

The procedure according to the invention is suitable in particular for the alignment of surfaces that are similar to the shape of the aperture, viewed in each case in the XY plane. In this connection, “similar” means that the surface to be aligned and the aperture can be interchanged by a similitude transformation, that is to say a geometrical transformation that can be made up of homothetic transformations and congruent transformations—displacement, rotation and reflection.

The procedure according to the invention has proven to be particularly successful for the alignment of a square or rectangular surface of an object, the first side of the square or rectangle preferably extending in the X direction and the second side of the square or rectangle preferably extending in the Y direction.

Furthermore, a mask with at least one preferably square or rectangular aperture where the aperture is larger than the surface to be aligned is favorably used.

The alignment of the object to be aligned can in principle be chosen freely at the beginning of the procedure according to the invention. Preferably, however, the first movement of the base plate takes place in the direction in which the contact area of the object to be aligned and the mask is at its greatest.

The base plate is expediently moved in the first direction, the second direction and/or the third direction, preferably in the X, Y and/or XY direction, by 150% to 200% of the maximum distance of the object from the mask in the respective direction. Particularly preferably, the base plate is moved in each of procedural steps (3) to (5) by 150% to 200% of the maximum distance of the object from the mask in the respective direction.

The speed of the movement of the base plate is preferably chosen such that the object to be aligned is neither misshapen, nor deformed nor damaged by the movement.

Furthermore, a mask of a thickness in the Z direction sufficient to avoid bending or gap changes is preferably chosen. Preferred thicknesses in the Z direction are in the range from 3 mm to 24 mm.

The procedure according to the invention allows extremely precise three-dimensional alignment and positioning of an object, such as for example an electrode, in a prescribed way, it being possible for the knowledge of the known alignment of the object to be advantageously used in subsequent procedural steps. For instance, the procedure according to the invention can be used in particular for positioning the aligned object in an exactly prescribed way on another object in an automated procedure.

The procedure according to the invention is therefore suitable in particular for the alignment of electrodes in the course of automated production of membrane electrode units. The structure of membrane electrode units of this type is described, for example, in WO 07/028626.

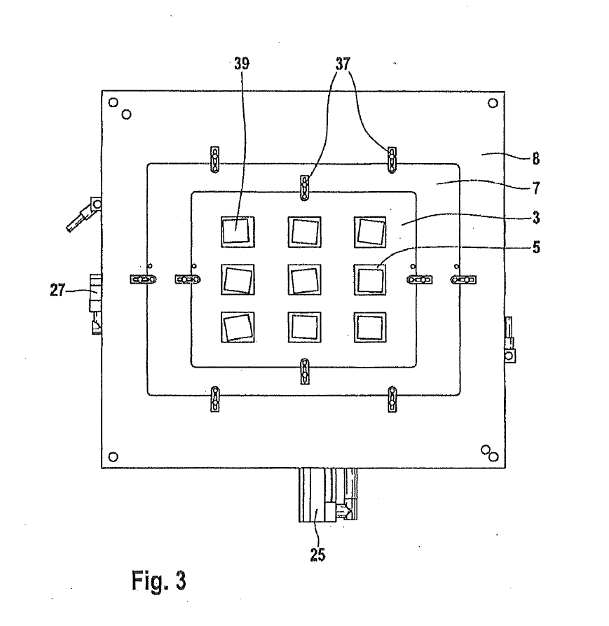

A particularly preferred variant of the procedure according to the invention is schematically shown in FIG. 3 to FIG. 6, where

FIG. 3 shows the positions of the objects to be aligned at the beginning,

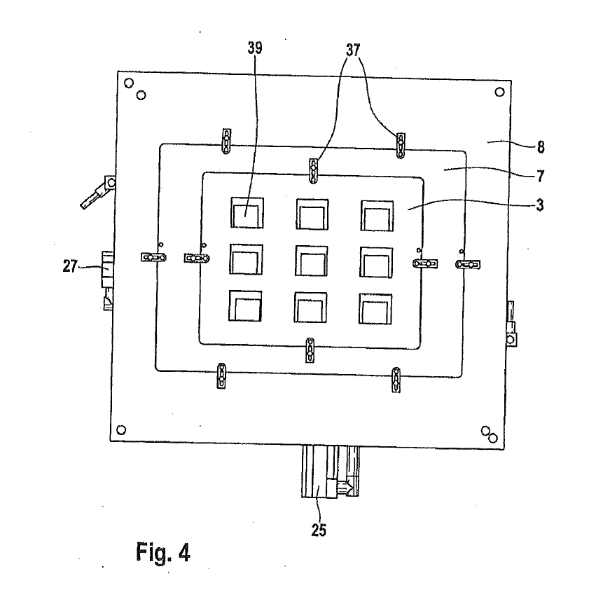

FIG. 4 shows the positions of the objects after the first movement of the base plate in the Y direction,

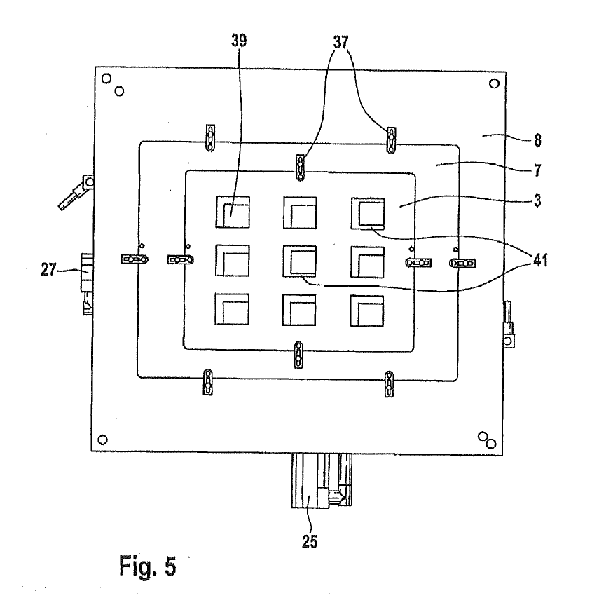

FIG. 5 shows the positions of the objects after the second movement of the base plate in the X direction and

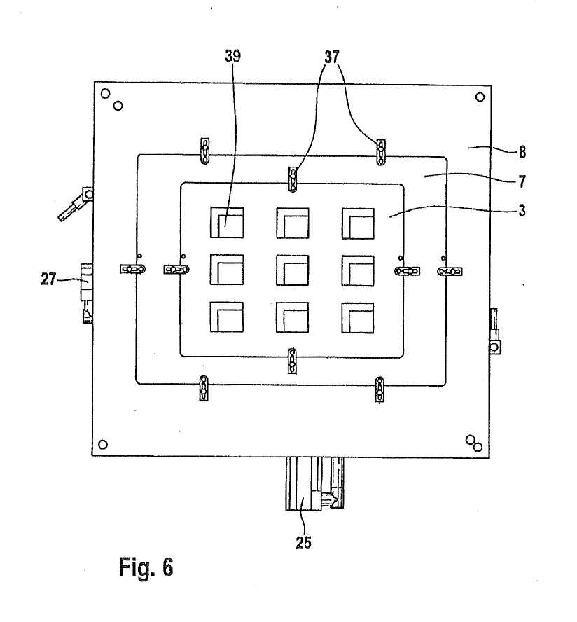

FIG. 6 shows the positions of the objects after the third movement of the base plate in the XY direction.

The objects to be aligned are in this case identified by the reference numeral (39). The apertures in the mask (3) are identified by the reference numeral (5).

In the present case, the mask (3) comprises three rows of three rectangular apertures (5), which are larger than the rectangular objects (39) to be aligned.

At the beginning, the objects (39) to be aligned are arranged more or less randomly in the apertures. The distances of the objects (39) from the respective edges of the apertures (5) vary greatly.

After the first movement of the base plate (1) in the Y direction, the objects (39) are arranged in the lower part of the apertures (5) and are touching the lower edges of the apertures (5). However, not all the lower edges of the objects (39) are touching the lower edge of the apertures (5) over the entire length. Rather, in some cases the objects (39) are turned slightly and, at least on one side, a gap can be seen between the lower edge of the objects (39) and the lower edge of the apertures (5).

After the second movement of the base plate in the X direction, the objects (39) are arranged in the bottom, right part of the apertures (5) and are touching both the right-hand edges of the apertures (5) and the lower edges of the apertures (5). However, not all the lower edges of the objects (39) are touching the lower edge of the apertures (5) over the entire length. Furthermore, not all the right-hand edges of the objects (39) are touching the right-hand edge of the apertures (5) over the entire length. Rather, in some cases the objects (39) are turned slightly and, at least on one side, a gap (41) can be seen between the right-hand edge of the objects and the right-hand edge of the apertures (5) and/or between the lower edge of the objects and the lower edge of the apertures (5).

After the third movement of the base plate in the XY direction, the objects (39) are arranged in the bottom, right part of the apertures (5) and are touching both the right-hand wall of the apertures (5) and the lower wall of the apertures (5). In this case, all the right-hand edges of the objects (39) are touching the right-hand edge of the apertures (5) over the entire length and all the lower edges of the objects (23) are touching the lower edge of the apertures (5) over the entire length. Slightly turned objects are no longer to be found.

1.-15. (canceled)

16. An apparatus for aligning a surface of at least one object (39) that extends in the XY plane, the apparatus comprising:
at least one movable base plate (1) with a surface extending in the XY plane;
above the base plate (1) in the Z direction, at least one mask (3) with at least one aperture (5), the mask (3) and the aperture (5) respectively extending in the XY plane;
at least one means for moving the base plate (25) in a first direction within the XY plane; and
at least one means for moving the base plate (27) in a second direction within the XY plane that is not parallel to the first direction.

17. The apparatus according to claim 16, wherein the surface of the side of the base plate (1) that is facing the mask (3) has an average roughness Ra, measured in accordance with DIN 4768, of less than 16 μm.

18. The apparatus according to claim 16, wherein the mask (3) comprises at least one aperture (5) with 0 to 10 corners.

19. The apparatus according to claim 16, wherein the means for moving the base plate (25, 27) in the first and second directions respectively comprise a rod and a drive, the rods being connected to the base plate and the first rod extending in the first direction and the second rod extending in the second direction.

20. The apparatus according to claim 16, wherein the apparatus also comprises a frame (7, 8) with an aperture, the base plate (1) and/or the mask (3) being arranged within the aperture.

21. The apparatus according to claim 20, wherein the mask (3) is connected to the frame (7, 8).

22. The apparatus according to claim 20, wherein the frame (7, 8) comprises on its outer side means for guiding at least one drive along the outer side of the frame (7, 8).

23. The apparatus according to claim 22, wherein the means for guiding a drive comprise at least one gap which extends in the first and/or second direction.

24. The apparatus according to claim 16, further comprising means for removing the aligned object.

25. A procedure for aligning a surface of at least one object (39) that extends in the XY plane, the procedure comprising:
(1) using an apparatus according to claim 16 in which the distance between the base plate (1) and the mask (3) in the Z direction is less than the spatial extent of the object (39) in the Z direction;
(2) placing the object (39) onto the base plate (1) in the region of an aperture (5) in the mask (3);
(3) initially moving the base plate (1) in the first direction;
(4) subsequently moving the base plate (1) in the second direction; and then
(5) moving the base plate (1) in a third direction within the XY plane that lies between the first and second directions.

26. The procedure according to claim 25, wherein the base plate (1) is
(3) initially moved in the X direction,
(4) subsequently moved in the Y direction,
(5) then moved in the XY direction.

27. The procedure according to claim 25, wherein a surface of an object (39) that is similar to the form of the aperture (5), viewed in each case in the XY plane, is

28. The procedure according to claim 25, wherein the mask (3) used includes at least one aperture (5) and at least one of the apertures (5) is larger than the surface to be aligned.

29. The procedure according to claim 25, wherein the base plate (1) is moved in the first, second and/or third direction by 150% to 200% of the maximum distance of the object (39) from the mask (3) in the respective direction.

30. The procedure according to claim 25, wherein the aligned object (39) is positioned on another object by means of an automated procedure.
